(19) United States
(12) Patent Application Publication
(10) Pub. No.: US 2018/0272524 A1
(43) Pub. Date: Sep. 27, 2018

(54) ASSIST DEVICE

(71) Applicant: JTEKT CORPORATION, Osaka-shi (JP)

(72) Inventors: Kazuyoshi Ohtsubo, Chiryu-shi (JP); Hisataka Sato, Toyota-shi (JP)

(73) Assignee: JTEKT CORPORATION, Osaka-shi (JP)

(21) Appl. No.: 15/920,496

(22) Filed: Mar. 14, 2018

(30) Foreign Application Priority Data
Mar. 22, 2017 (JP) 2017-056226

(51) Int. Cl. B25J 9/00; A61H 3/00; A61H 1/02; G06F 1/16

(52) U.S. Cl. CPC B25J 9/0006; A61H 3/00; A61H 1/024; A61H 2201/1215; A61H 2003/007; A61H 2201/165; A61H 2203/0406; G06F 1/163

(57) ABSTRACT

An assist device includes a body wearing unit and an actuator unit. The body wearing unit includes a waist wearing portion configured to be worn around a waist of a user, an upper half body wearing portion configured to be worn at a position in an upper half of a body of the user, and a frame portion connecting the waist wearing portion and the upper half body wearing portion to each other. A virtual pivot axis extending in a right-left direction of the user wearing the assist device is set at the waist wearing portion. The frame portion is connected to the waist wearing portion via a pivot mechanism that supports the frame portion such that the frame portion is pivotable relative to the waist wearing portion about the virtual pivot axis.

### INCORPORATION BY REFERENCE

The disclosure of Japanese Patent Application No. 2017-056226 filed on Mar. 22, 2017 including the specification, drawings and abstract is incorporated herein by reference in its entirety.

### BACKGROUND

### 1. Technical Field

The disclosure relates to an assist device that assists the motion of an assist target body part of a user.

### 2. Description of Related Art

Japanese Unexamined Patent Application Publication No. 2016-119996 (JP 2016-119996 A), for example, discloses a leg power assist device including a thigh pivoting arm, a lower leg arm, a base portion to which actuator-related members are attached, a waist wearing portion to which the base portion is fixed, and shoulder belts. The thigh pivoting arm is worn on the thigh of a user to cause the thigh to pivot, while the lower leg arm is worn on the lower leg of the user to cause the lower leg to pivot. The waist wearing portion is a belt member that is wound around the waist of the user, and the waist wearing portion holds the base portion on the side of the waist of the user. The shoulder belts suspend the waist wearing portion on the waist of the user.

### SUMMARY

In the leg power assist device described in JP 2016-119996 A, the belt-shaped waist wearing portion to which the base portion is fixed is wound around the waist of the user and suspended by the shoulder belts, and thus, the waist wearing portion is not firmly fixed at the position of the waist of the user and thus is in a suspended state. Therefore, it seems that the waist wearing portion is easily slidable, for example, in an up-down direction from the position of the waist of the user. The thigh pivoting arm worn on the thigh of the user is caused to pivot about a pivot axis set at the base portion so as to transmit the assist torque to the thigh, and the thigh pivoting arm receives reaction force from the thigh, and the reaction force is transmitted to the base portion. Herein, when the base portion (i.e. the waist wearing portion) is not firmly fixed at the position of the waist of the user, the reaction force slides the base portion, for example, in the up-down direction, and as a result, there is a possibility that the assist torque cannot be efficiently transmitted to the thigh.

The disclosure provides an assist device that hardly moves on the body of a user when the assist device is worn by the user and thus can efficiently transmit an assist toque to an assist target body part of the user.

An aspect of the disclosure relates to an assist device including a body wearing unit configured to be worn on a body of a user including a region around an assist target body part of the user; and an actuator unit configured to be attached to the body wearing unit and to the assist target body part so as to assist a motion of the assist target body part. The body wearing unit includes a waist wearing portion configured to be worn around a waist of the user, an upper half body wearing portion configured to be worn at a position in an upper half of the body of the user, and a frame portion connecting the waist wearing portion and the upper half body wearing portion to each other. A virtual pivot axis extending in a right-left direction of the user wearing the assist device is set at the waist wearing portion. The frame portion is connected to the waist wearing portion via a pivot mechanism configured to support the frame portion such that the frame portion is pivotable relative to the waist wearing portion about the virtual pivot axis.

According to the above-described aspect, the body wearing unit includes the waist wearing portion configured to be worn around the waist of the user, the upper half body wearing portion configured to be worn at a position in the upper half of the body of the user, and the frame portion connecting the waist wearing portion and the upper half body wearing portion to each other. Therefore, the wearing position of the waist wearing portion with respect to the wearing position of the upper half body wearing portion is reliably positioned by the frame portion. That is, even in the state where the waist wearing portion is slidable, for example, in the up-down direction relative to the user wearing the assist device, when the upper half body wearing portion (or the frame portion) is attached to the user such that the upper half body wearing portion (or the frame portion) is unlikely to slide, for example, in the up-down direction, the position of the waist wearing portion is not displaced even if reaction force against the assist torque is received. Therefore, the assist torque can be efficiently transmitted to the assist target body part of the user. Further, the frame portion is supported so as to be pivotable relative to the waist wearing portion about the virtual pivot axis. Therefore, for example, even when the user makes a motion of bending the upper half of the body forward or backward, the waist wearing portion does not slide in the up-down direction relative to the user, while the frame portion pivots forward or backward relative to the waist wearing portion. Thus, the waist wearing portion can be maintained on the waist of the user. Accordingly, the assist torque can be efficiently transmitted to the assist target body part of the user.

In the above-described aspect, a portion of the body wearing unit, to which the actuator unit is attached, may be the frame portion; the assist target body part to which the actuator unit is attached may be a thigh; and the actuator unit may be attached to the frame portion via an opening angle imparting mechanism configured to cause the actuator unit to pivot in the right-left direction relative to the frame portion in accordance with an opening state of the thigh in the right-left direction, when the user wearing the assist device opens the thigh in the right-left direction.

In the above-described configuration, the actuator unit is attached to the frame portion via the opening angle imparting mechanism. Therefore, for example, even when the user opens each of the thighs in the right-left direction to squat down when lifting up a heavy thing (heavy object) at the user's feet, since the actuator unit is opened in the right-left direction so as to follow the corresponding thigh opened in the right-left direction, the assist torque can be efficiently transmitted to the assist target body part of the user.

In the above-described aspect, the waist wearing portion may include a right waist wearing portion configured to be worn on a right half of the body of the user, and a left waist wearing portion configured to be worn on a left half of the body of the user; the upper half body wearing portion may include a right upper half body wearing portion configured to be worn on a right half of the body of the user, and a left upper half body wearing portion configured to be worn on a left half of the body of the user; and the frame portion may include a right frame portion connecting the right waist wearing portion and the right upper half body wearing portion to each other, and a left frame portion connecting the left waist wearing portion and the left upper half body wearing portion to each other.

In the above-described configuration, the body wearing unit can be appropriately realized by a right half body wearing portion including the right waist wearing portion, the right upper half body wearing portion, and the right frame portion and configured to be worn on the right half of the body of the user, and a left half body wearing portion including the left waist wearing portion, the left upper half body wearing portion, and the left frame portion and configured to be worn on the left half of the body of the user.

In the above-described aspect, the waist wearing portion may include a right waist wearing portion configured to be worn on a right half of the body of the user, and a left waist wearing portion configured to be worn on a left half of the body of the user; and the frame portion may include a right-left link frame portion and a rear frame portion, the right-left link frame portion linking the pivot mechanism in the right waist wearing portion and the pivot mechanism in the left waist wearing portion, the rear frame portion connecting the right-left link frame portion and the upper half body wearing portion to each other, and the rear frame portion being disposed on a back side of the user.

In the above-described configuration, the waist wearing portion and the frame portion can be appropriately realized.

In the above-described aspect, the upper half body wearing portion may include a shoulder belt extending from a front side of the upper half of the body of the user wearing the assist device to reach a back side of the user, through a position on a shoulder of the user.

In the above-described configuration, the upper half body wearing portion can be appropriately realized by, for example, only the shoulder belt, or by the shoulder belt, the chest wearing portion, and so on.

In the above-described aspect, the shoulder belt may include a right shoulder belt extending from a right side in the front side of the upper half of the body of the user wearing the assist device to reach a left side in the back side of the user, through a position on a right shoulder of the user; and a left shoulder belt extending from a left side in the front side of the upper half of the body of the user wearing the assist device to reach a right side in the back side of the user, through a position on a left shoulder of the user.

In the above-described configuration, since the shoulder belt includes the right shoulder belt and the left shoulder belt and the right shoulder belt and the left shoulder belt cross each other on the back side of the user, even when the user has a stooped posture, it is possible to correct the stooped posture so as to stretch the back muscles. Further, the right shoulder belt and the left shoulder belt (the upper half body wearing portion) can be firmly fixed around the shoulders of the user.

In the above-described aspect, a release mechanism may be provided for the shoulder belt, the release mechanism being configured to release the shoulder belt when a load greater than a preset release load is applied to the shoulder belt attached to the user.

In the above-described configuration, even when the actuator unit becomes in a locked state so that the user is fixed in a posture where the load is large for the user, since the release mechanism is provided, it is possible to appropriately release the user from the assist device in the locked state.

In the above-described aspect, the upper half body wearing portion may include a chest wearing portion extending from a right armpit of the user wearing the assist device to a left armpit of the user via a chest of the user.

In the above-described configuration, since the upper half body wearing portion includes the chest wearing portion extending from the right armpit to the left armpit via the chest, the upper half body wearing portion can be appropriately fixed on the upper half of the body of the user.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view for explaining an example of the overall configuration of an assist device of a first embodiment;

FIG. 2 is a perspective view for explaining an example of the external appearance of a body wearing unit in the assist device shown in FIG. 1;

FIG. 3 is a perspective view for explaining an example of the external appearance of an actuator unit in the assist device shown in FIG. 1;

FIG. 4 is an exploded perspective view for explaining an example of the internal structure of the actuator unit;

FIG. 5 is a sectional view of the assist device taken along a ZY plane passing through a virtual pivot axis and is a sectional view for explaining examples of the structure of a pivot mechanism and the structure of an opening angle imparting mechanism;

FIG. 6 is a diagram for explaining a state in which a user wearing the assist device of the first embodiment stretches the back muscles;

FIG. 7 is a diagram for explaining a state in which the user takes a forward-bent posture from the state shown in FIG. 6 so that a frame portion and an upper half body wearing portion pivot about the virtual pivot axis;

FIG. 8 is a perspective view for explaining an example of the overall configuration of an assist device of a second embodiment;

FIG. 9 is a perspective view for explaining an example of the external appearance of a body wearing unit in the assist device shown in FIG. 8;

FIG. 10 is a perspective view for explaining a state in which a frame portion in the body wearing unit shown in FIG. 9 is opened toward the right and left sides in order to facilitate attachment to a user;

FIG. 11 is a schematic diagram for explaining an example of the structure of a release mechanism of a shoulder belt;

FIG. 12 is a schematic diagram for explaining an example in which the release mechanism shown in FIG. 11 becomes in a released state;

FIG. 13 is a diagram for explaining a state in which the user wearing the assist device of the second embodiment takes a forward-bent posture so that the frame portion and an upper half body wearing portion pivot about a virtual pivot axis; and

FIG. 14 is a diagram for explaining a state in which the user is released by the release mechanisms of the shoulder belts after an actuator unit becomes in a locked state in the state shown in FIG. 13.

### DETAILED DESCRIPTION OF EMBODIMENTS

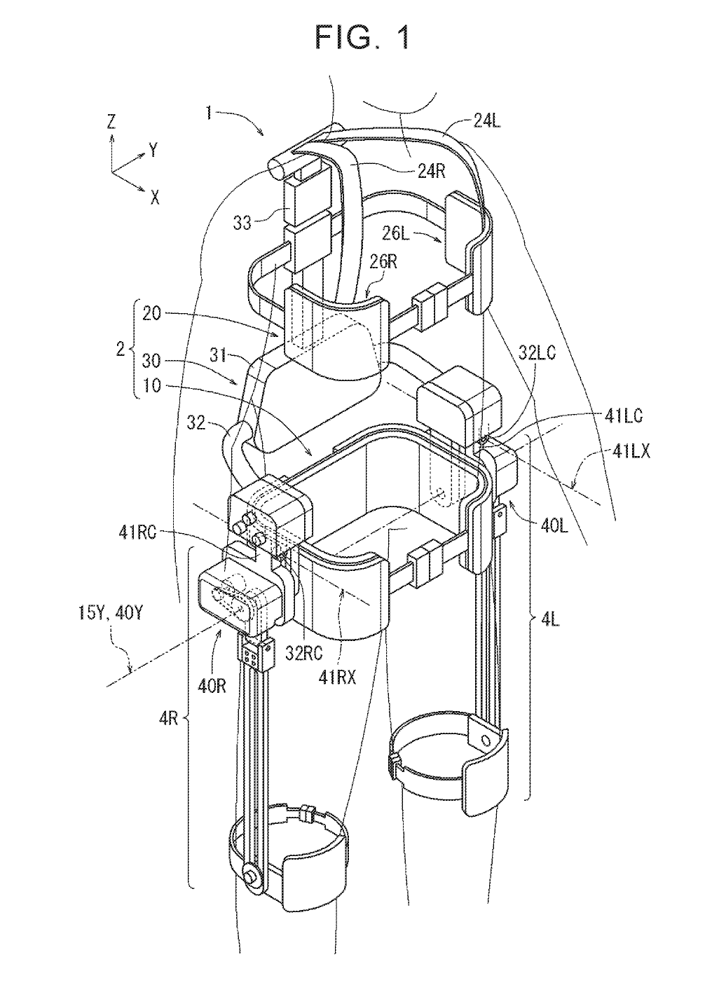

Hereinbelow, an assist device 1 according to a first embodiment will be described with reference to FIGS. 1 to 7. The assist device 1 according to the first embodiment is, for example, a device that assists pivoting of the thighs relative to the waist when a user lifts up an object (for example, a parcel or baggage) or when the user walks. In FIGS. 1 to 7, X-, Y-, and Z-axes are perpendicular to each other, and when viewed from the user wearing the assist device 1, the X-axis direction corresponds to a forward direction, the Y-axis direction corresponds to a leftward direction, and the Z-axis direction corresponds to an upward direction.

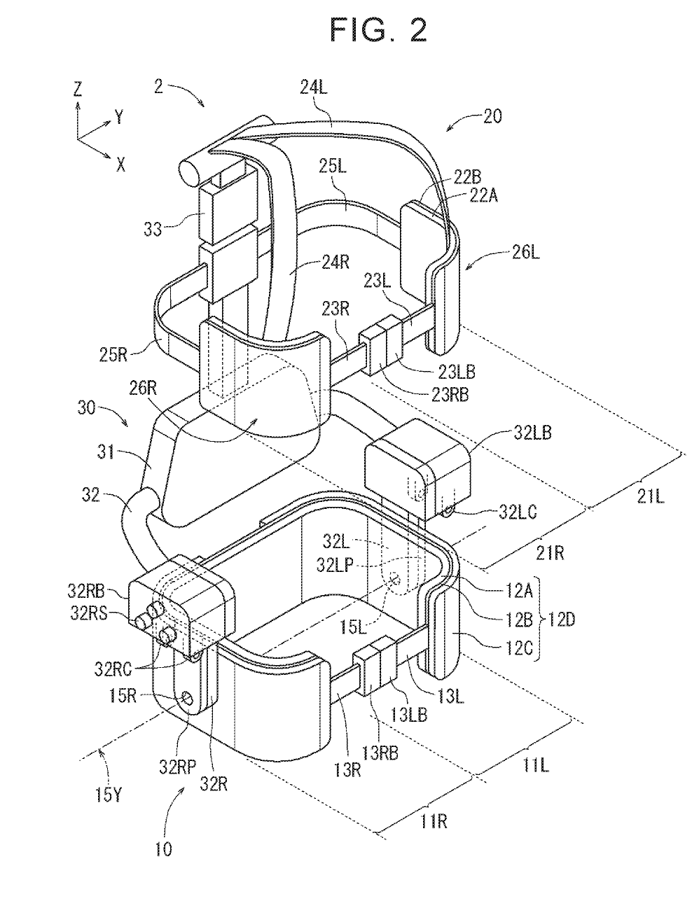

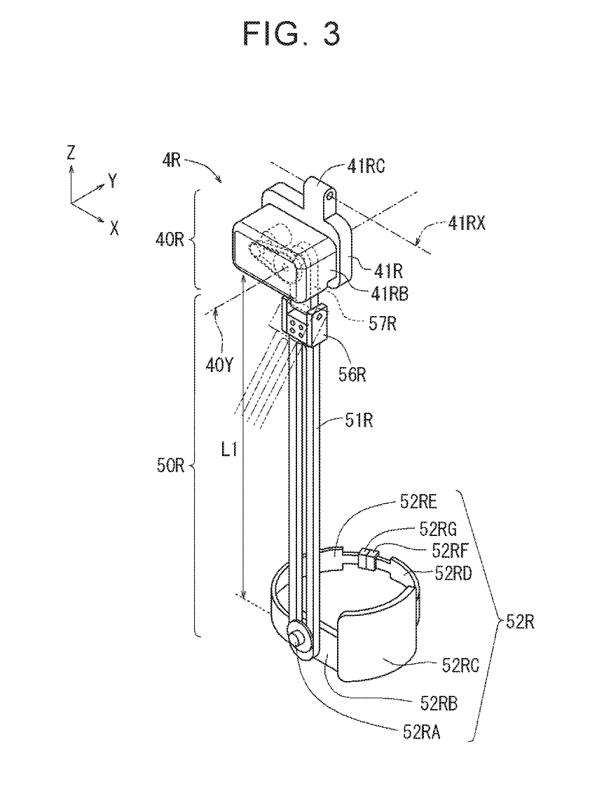

Referring to FIGS. 1 to 7, the assist device 1 of the first embodiment will be described. FIG. 1 shows the overall configuration of the assist device 1 of the first embodiment. The assist device 1 includes a body wearing unit 2 (see FIG. 2), an actuator unit 4R (see FIG. 3), and an actuator unit 4L. The body wearing unit 2 is configured to be worn on the body including regions around assist target body parts (the thighs in an example of this embodiment) of the user. The actuator unit 4R (4L) is attached to the body wearing unit 2 and to the assist target body part so as to assist the motion of the assist target body part. Hereinbelow, the body wearing unit 2 and the actuator unit 4R will be described in this order.

Referring to FIG. 2, the overall configuration of the body wearing unit 2 will be described. As shown in FIG. 2, the body wearing unit 2 includes a waist wearing portion 10 to be worn around the waist of the user, an upper half body wearing portion 20 to be worn at any position (an arbitrary position) in the upper half of the body of the user, and a frame portion 30 connecting the waist wearing portion 10 and the upper half body wearing portion 20 to each other.

The waist wearing portion 10 includes a right waist wearing portion 11R to be worn around the waist of the right half of the body of the user, and a left waist wearing portion 11L to be worn around the waist of the left half of the body of the user. The waist wearing portion 10 includes a waist applying portion 12D including three layers, i.e. a waist pad portion 12A with a predetermined thickness to be wound around the waist of the user, a waist cloth portion 12B disposed around an outer periphery of the waist pad portion 12A, and each of waist base portions 12C with a predetermined thickness and disposed around an outer periphery of the waist cloth portion 12B. The waist pad portion 12A is formed by, for example, an elastic member, while the waist base portions 12C are made of, for example, a resin. In order to facilitate attaching to and detaching from the user, the right waist wearing portion 11R and the left waist wearing portion 11L respectively include a buckle 13RB provided on a length-adjustable belt 13R and a buckle 13LB provided on a length-adjustable belt 13L.

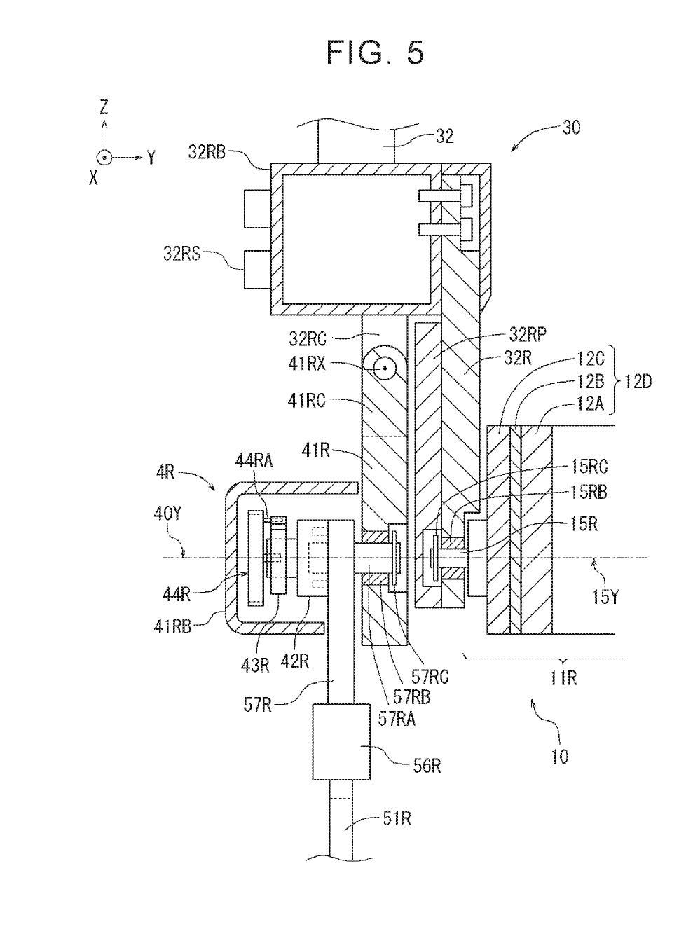

In the waist wearing portion 10, a virtual pivot axis 15Y is set so as to extend in the right-left direction of the user at hip joints of the user when the waist wearing portion 10 is worn by the user. At a crossing position between the virtual pivot axis 15Y and the right waist wearing portion 11R, a pivot shaft portion 15R projecting rightward along the virtual pivot axis 15Y is fixed to the waist base portion 12C (see FIG. 5). Likewise, at a crossing position between the virtual pivot axis 15Y and the left waist wearing portion 11L, a pivot shaft portion 15L projecting leftward along the virtual pivot axis 15Y is fixed to the waist base portion 12C.

The upper half body wearing portion 20 includes a right upper half body wearing portion 21R to be worn at any position (an arbitrary position) in the right upper half of the body of the user and a left upper half body wearing portion 21L to be worn at any position (an arbitrary position) in the left upper half of the body of the user. The right upper half body wearing portion 21R includes a right chest wearing portion 26R, a belt 23R and a buckle 23RB, a belt 25R, and a right shoulder belt 24R. Likewise, the left upper half body wearing portion 21L includes a left chest wearing portion 26L, a belt 23L and a buckle 23LB, a belt 25L, and a left shoulder belt 24L. The right shoulder belt 24R, the left shoulder belt 24L, and the belts 23R, 23L, 25R, 25L are adjustable in length, while the buckles 23RB, 23LB facilitate attaching and detaching of the upper half body wearing portion 20 to and from the user.

The right chest wearing portion 26R and the left chest wearing portion 26L each include two layers, i.e. a pad portion 22A (e.g. an elastic member) with a predetermined thickness to be worn to cover the chest of the user and a cloth portion 22B disposed around an outer periphery of the pad portion 22A. The rear side of the belt 25R is connected to a rear frame portion 33, the front side of the belt 25R is connected to the rear side of the right chest wearing portion 26R, and the buckle 23RB is connected to the front side of the right chest wearing portion 26R via the belt 23R. Likewise, the rear side of the belt 25L is connected to the rear frame portion 33, the front side of the belt 25L is connected to the rear side of the left chest wearing portion 26L, and the buckle 23LB is connected to the front side of the left chest wearing portion 26L via the belt 23L. In this way, a chest wearing portion (the right chest wearing portion 26R and the left chest wearing portion 26L) extending from the right armpit of the user to the left armpit of the user via the chest of the user is formed by the path including the belt 25R, the right chest wearing portion 26R, the belt 23R (the buckle 23RB), the belt 23L (the buckle 23LB), the left chest wearing portion 26L, and the belt 25L.

The front side of the right shoulder belt 24R is connected to the front upper side of the right chest wearing portion 26R and the rear side of the right shoulder belt 24R is connected to the rear frame portion 33. In this way, when the assist device 1 is worn by the user, the right shoulder belt 24R extends from the front side (front right side) of the upper half of the body of the user, then on the shoulder (right shoulder) of the user, to reach the back side of the user (in other words, the right shoulder belt 24R extends from the front side (front right side) of the upper half of the body of the user, to reach the back side of the user, through a position on the shoulder (right shoulder) of the user). Likewise, the front side of the left shoulder belt 24L is connected to the front upper side of the left chest wearing portion 26L and the rear side of the left shoulder belt 24L is connected to the rear frame portion 33. In this way, when the assist device 1 is worn by the user, the left shoulder belt 24L extends from the front side (front left side) of the upper half of the body of the user, then on the shoulder (left shoulder) of the user, to reach the back side of the user (in other words, the left shoulder belt 24L extends from the front side (front left side) of the upper half of the body of the user, to reach the back side of the user, through a position on the shoulder (left shoulder) of the user). The rear side of the right shoulder belt 24R may be connected to the left side of the rear frame portion 33, while the rear side of the left shoulder belt 24L may be connected to the right side of the rear frame portion 33 such that the right shoulder belt 24R and the left shoulder belt 24L cross each other on the back side of the user.

The frame portion 30 includes a right-left link frame portion 32, boxes 32RB, 32LB, pivotal portions 32R, 32L, pads 32RP, 32LP, a box 31, the rear frame portion 33, and so on. The right-left link frame portion 32 links to each other the crossing position between the virtual pivot axis 15Y and the right waist wearing portion 11R (i.e. the pivot shaft portion 15R) and the crossing position between the virtual pivot axis 15Y and the left waist wearing portion 11L (i.e. the pivot shaft portion 15L). That is, the right-left link frame portion 32 links the pivot shaft portion 15R and the pivot shaft portion 15L. As shown in FIGS. 5 and 2, the right-left link frame portion 32 is connected to the pivot shaft portion 15R via the box 32RB and the pivotal portion 32R. Likewise, as shown in FIG. 2, the right-left link frame portion 32 is connected to the pivot shaft portion 15L via the box 32LB and the pivotal portion 32L. The right-left link frame portion 32 is curved so as to be disposed on the back side of the user and positions the waist wearing portion 10 with respect to the frame portion 30. The box 31 houses, for example, a control device and a battery for the actuator units 4R, 4L. The rear frame portion 33 is disposed on the back side of the user so as to connect the right-left link frame portion 32 and the upper half body wearing portion 20 to each other and is adjustable in vertical length.

The pivotal portion 32R and the pad 32RP are attached to the pivot shaft portion 15R so as to be pivotable about the virtual pivot axis 15Y (see FIG. 5). The box 32RB is provided in the pivotal portion 32R at a position on the side opposite to the pivot shaft portion 15R. A holding portion 32RC configured to hold the actuator unit 4R is provided below the box 32RB (see FIG. 5). The box 32RB has a plurality of input portions 32RS configured to, for example, provide instructions regarding operation states of the assist device 1, such as ON/OFF of a power supply and an assist multiplying factor of the assist device 1. Since the pivot shaft portion 15L, the pivotal portion 32L, the box 32LB, and so on are the same as those described above, a description thereof will be omitted. With the configuration described above, the frame portion 30 and the upper half body wearing portion 20 are pivotable relative to the waist wearing portion 10 about the virtual pivot axis 15Y. Details of the structure of a pivot mechanism configured to support the frame portion 30 (and the upper half body wearing portion 20) such that the frame portion 30 (and the upper half body wearing portion 20) is (are) pivotable relative to the waist wearing portion 10 about the virtual pivot axis 15Y will be described later.

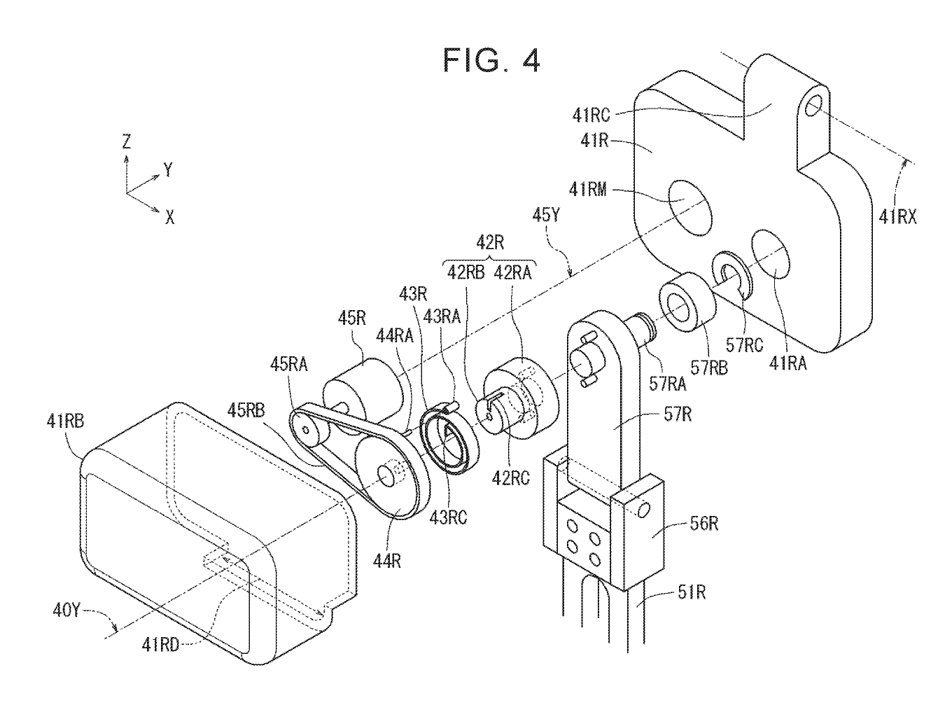

Referring to FIGS. 3 and 4, the external appearance and internal structure of the actuator unit 4R will be described. FIG. 3 shows the external appearance of the (right-side) actuator unit 4R that is connected to the holding portion 32RC provided below the box 32RB shown in FIG. 2. Since the (left-side) actuator unit 4L (see FIG. 1) that is connected to a holding portion 32LC provided below the box 32LB is symmetrical with the actuator unit 4R, a description thereof will be omitted.

As shown in FIG. 3, the actuator unit 4R includes a torque generating portion 40R and a torque transmitting portion 50R. The torque generating portion 40R includes an actuator base portion 41R and a cover 41RB. Members housed in the cover 41RB will be described later.

The torque transmitting portion 50R includes a thigh arm 51R and a thigh wearing portion 52R. As shown in FIG. 4, the thigh arm 51R is connected to an assist arm 57R via a connecting portion 56R. The assist arm 57R is pivoted by a combined torque obtained by combining an assist torque generated by the actuator unit 4R and a user torque generated by the motion of the thigh of the user. As shown by alternate long and two short dashes lines in FIG. 3, the connecting portion 56R supports the thigh arm 51R such that the thigh arm 51R is pivotable relative to the assist arm 57R so as to open in the rightward direction.

As shown in FIG. 3, the thigh wearing portion 52R includes an adjusting portion 52RA, a thigh base portion 52RB, a pad portion 52RC, belts 52RD, 52RE, and buckles 52RF, 52RG. The adjusting portion 52RA can adjust a distance L1 from the actuator base portion 41R to the thigh wearing portion 52R in accordance with the length of the thigh of the user. The thigh base portion 52RB and the pad portion 52RC are each formed by, for example, an elastic member.

Next, referring to FIG. 4, the members housed in the cover 41RB will be described. The cover 41RB houses the assist arm 57R having a shaft portion 57RA, a speed reducer 42R, a spiral spring 43R, a driven pulley 44R, a transmission belt 45RB, a drive pulley 45RA, an electric motor 45R, and so on. Although not shown, an arm pivot angle detection unit (a pivot angle sensor or the like) configured to detect a pivot angle of the assist arm 57R relative to the actuator base portion 41R is provided in the cover 41RB. The electric motor 45R is provided with a motor rotation angle detection unit (encoder or the like) that can detect a rotation angle of a motor shaft.

The actuator base portion 41R is provided with a connecting portion 41RC, a pivot shaft support hole 41RA, a motor support hole 41RM, and so on. The connecting portion 41RC is connected to the holding portion 32RC (see FIG. 2) such that the actuator base portion 41R is pivotable relative to the holding portion 32RC about a pivot axis 41RX. A bearing 57RB is press-fitted into the pivot shaft support hole 41RA, while the shaft portion 57RA is press-fitted into the bearing 57RB. A coming-off preventing ring 57RC is fitted around a distal end portion, protruding from the bearing 57RB, of the shaft portion 57RA (see FIG. 5). Consequently, the assist arm 57R is supported so as to be pivotable relative to the actuator base portion 41R about a pivot axis 40Y. The assist arm 57R is connected to a first input/output portion 42RA of the speed reducer 42R and is caused to pivot together with the first input/output portion 42RA. The bearing 57RB, the shaft portion 57RA, the speed reducer 42R, the spiral spring 43R, and the driven pulley 44R are disposed coaxially along the pivot axis 40Y.

The speed reducer 42R has a reduction ratio n. Thus, when the first input/output portion 42RA is caused to pivot by a pivot angle θ, the speed reducer 42R causes a second input/output portion 42RB to pivot by a pivot angle nθ. When the second input/output portion 42RB is caused to pivot by a pivot angle nθ, the speed reducer 42R causes the first input/output portion 42RA to pivot by a pivot angle θ. The second input/output portion 42RB of the speed reducer 42R is provided with a groove 42RC, while an inner end portion 43RC of the spiral spring 43R is fitted into the groove 42RC.

The spiral spring 43R stores the assist torque transmitted from the electric motor 45R and the user torque transmitted by the motion of the thigh of the user via the assist arm 57R and the speed reducer 42R, and as a result, the spiral spring 43R stores the combined torque obtained by combining the assist torque and the user torque. Then, the combined torque stored in the spiral spring 43R causes the thigh arm 51R to pivot via the speed reducer 42R and the assist arm 57R. The spiral spring 43R has a spring constant K and has a spiral shape with the inner end portion 43RC on the center side and with an outer end portion 43RA on the outer peripheral side. The inner end portion 43RC is fitted into the groove 42RC formed in the second input/output portion 42RB of the speed reducer 42R so as to be supported by the second input/output portion 42RB. A transmission shaft 44RA provided in the driven pulley 44R is fitted into the outer end portion 43RA so that the outer end portion 43RA is supported by the transmission shaft 44RA. The combined torque stored in the spiral spring 43R is calculated based on an angle change amount from a no-load state and the spring constant K. For example, the combined torque stored in the spiral spring 43R is calculated based on a pivot angle of the assist arm 57R (obtained by the arm pivot angle detection unit not shown), a rotation angle of the motor shaft of the electric motor 45R (obtained by the encoder not shown), and the spring constant K of the spiral spring 43R. Then, the user torque is extracted from the calculated combined torque, and the assist torque corresponding to the user torque is output from the electric motor 45R. Calculation of the angle change amount, calculation of the combined torque, extraction of the user torque, calculation of the assist torque, output of a control signal to the electric motor, and so on are performed by the control device housed in the box 31 (or the box 32RB, 32LB).

The driven pulley 44R is supported so as to be rotatable about the pivot axis 40Y. The transmission shaft 44RA protruding toward the spiral spring 43R is provided near an outer peripheral edge of the driven pulley 44R. The transmission shaft 44RA is fitted into the outer end portion 43RA of the spiral spring 43R so as to move the position of the outer end portion 43RA about the pivot axis 40Y. The driven pulley 44R is rotationally driven by the electric motor 45R via the transmission belt 45RB and the drive pulley 45RA. The driven pulley 44R rotationally driven by the electric motor 45R stores the assist torque in the spiral spring 43R via the transmission shaft 44RA.

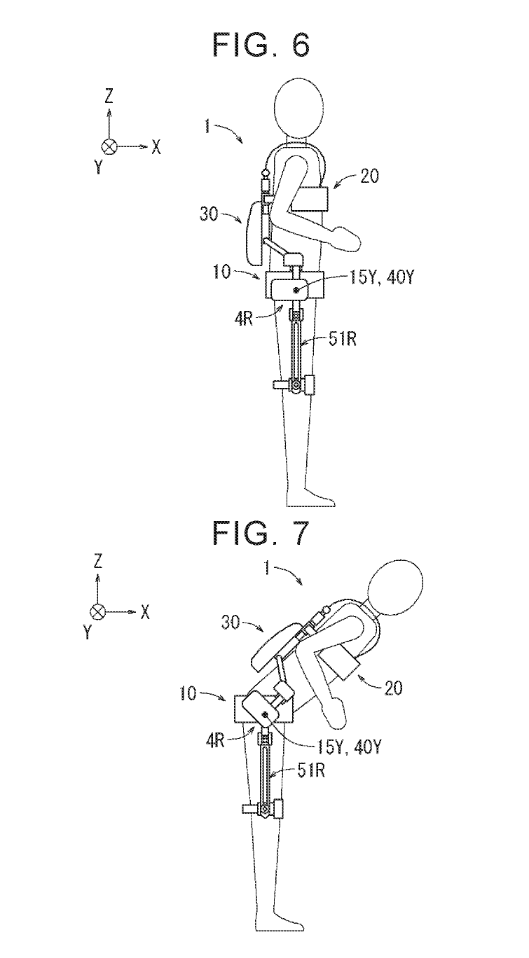

The structure (FIG. 5) and operation (FIGS. 6 and 7) of a pivot mechanism and the structure of an opening angle imparting mechanism (FIG. 5) will be described. Referring to a sectional view shown in FIG. 5, details of the pivot mechanism configured to support the frame portion 30 such that the frame portion 30 is pivotable relative to the waist wearing portion 10 about the virtual pivot axis 15Y will be described. While the pivot mechanism including the pivot shaft portion 15R provided in the right waist wearing portion 11R will be described with reference to FIG. 5, a pivot mechanism including the pivot shaft portion 15L (see FIG. 2) provided in the left waist wearing portion 11L (see FIG. 2) is the same as that shown in FIG. 5 and therefore a description of the pivot mechanism including the pivot shaft portion 15L will be omitted.

The pivot mechanism includes the pivot shaft portion 15R and a hole that is provided to extend through the pivotal portion 32R such that the pivot shaft portion 15R is fitted in the hole. The pivot shaft portion 15R is provided (fixed) at the position, where the virtual pivot axis 15Y crosses the waist base portion 12C of the right waist wearing portion 11R, so as to protrude outward from the right waist wearing portion 11R along the virtual pivot axis 15Y. The pivot shaft portion 15R is fitted into the hole in the lower part of the pivotal portion 32R of the frame portion 30 via a bearing 15RB. A coming-off preventing ring 15RC is fitted around a distal end portion, protruding from the bearing 15RB, of the pivot shaft portion 15R. While the pivot shaft portion 15R is fixed to the right waist wearing portion 11R and the hole is provided in the pivotal portion 32R in the description of this embodiment, the pivot shaft portion 15R may be fixed to the pivotal portion 32R and the hole may be provided in the right waist wearing portion 11R. By the pivot mechanism described above, as shown in FIGS. 6 and 7, the frame portion 30 (the frame portion 30 and the upper half body wearing portion 20) is caused to pivot relative to the waist wearing portion 10 about the virtual pivot axis 15Y in accordance with a motion of the user. As a result, as shown in FIGS. 6 and 7, for example, even when the posture of the user is changed from an upright posture to a forward-bent posture, the waist wearing portion 10 does not move from the position of the waist of the user in an up-down direction. Thus, the assist torque can be efficiently transmitted via the thigh arm 51R.

Next, the opening angle imparting mechanism configured to cause the actuator unit 4R to pivot in the right-left direction relative to the frame portion 30 will be described. Hereinbelow, while the opening angle imparting mechanism will be described with respect to the actuator unit 4R that is attached to the right side of the waist wearing portion 10, an opening angle imparting mechanism for the actuator unit 4L (see FIG. 1) that is attached to the left side of the waist wearing portion 10 is the same as that for the actuator unit 4R and therefore a description of the opening angle imparting mechanism for the actuator unit 4L will be omitted. The opening angle imparting mechanism includes a first opening angle imparting mechanism formed by the holding portion 32RC and the connecting portion 41RC in FIG. 5 and a second opening angle imparting mechanism formed by the connecting portion 56R in FIG. 4.

In FIG. 5, the first opening angle imparting mechanism is formed by the holding portion 32RC provided below the box 32RB and the connecting portion 41RC provided in the actuator base portion 41R of the actuator unit 4R. The connecting portion 41RC is supported by the holding portion 32RC so as to be pivotable relative to the holding portion 32RC about the pivot axis 41RX extending in the front-rear direction. Therefore, the actuator unit 4R is pivotable relative to the waist wearing portion 10 about the pivot axis 41RX. By this pivoting, when, for example, the user opens the thigh to the right or left, a first opening angle as an angle formed between a longitudinal direction of the pivotal portion 32R and a longitudinal direction of the actuator base portion 41R in FIG. 5 changes. That is, the first opening angle imparting mechanism is a mechanism that opens the entirety of the actuator unit 4R (i.e., that causes the entire actuator unit 4R to pivot) in the right-left direction relative to the waist wearing portion 10, in other words, a mechanism that opens the entire actuator unit 4L (i.e., that causes the entire actuator unit 4L to pivot) in the right-left direction relative to the waist wearing portion 10.

In FIG. 4, the second opening angle imparting mechanism is formed by the connecting portion 56R connecting the assist arm 57R and the thigh arm 51R to each other. As shown in FIG. 3, the connecting portion 56R connects the thigh arm 51R to the assist arm 57R such that the thigh arm 51R is pivotable in the right-left direction relative to the assist arm 57R. By this pivoting, when, for example, the user opens the thigh to the right or left, a second opening angle as an angle formed between a longitudinal direction of the assist arm 57R and a longitudinal direction of the thigh arm 51R in FIG. 4 changes. That is, the second opening angle imparting mechanism is a mechanism that opens the thigh arm 51R (i.e., that causes the thigh arm 51R to pivot) in the right-left direction relative to the assist arm 57R, in other words, a mechanism that opens a left thigh arm (that causes the left thigh arm to pivot) in the right-left direction relative to a left assist arm. The allowable opening degrees (allowable opening angles) of the first opening angle imparting mechanism and the second opening angle imparting mechanism are adjustable so as to allow the user to make an outward rotation motion and an outward pivoting (outward moving) motion of the hip joint of the thigh of the user, and in addition, an inward rotation motion and an inward pivoting (inward moving) motion of the hip joint of the thigh of the user. Consequently, the thigh arm 51R can operate so as not to impede the motion of the user, and thus, the assist torque can be efficiently transmitted to the thigh.

The opening angle imparting mechanism may include both the first opening angle imparting mechanism and the second opening angle imparting mechanism or may include only one of them. When the opening angle imparting mechanism includes both the first opening angle imparting mechanism and the second opening angle imparting mechanism, the sum of the first opening angle and the second opening angle is an opening angle.

The pivot axis 40Y of the actuator unit 4R is set to coincide with the virtual pivot axis 15Y when the connecting portion 41RC and the actuator base portion 41R that are supported by the holding portion 32RC are parallel to the pivotal portion 32R (i.e. when the first opening angle is zero) as shown in FIG. 5. Therefore, in the state where the actuator base portion 41R is parallel to the pivotal portion 32R (the first opening angle is zero), no matter how the frame portion 30 is caused to pivot relative to the waist wearing portion 10 about the virtual pivot axis 15Y, the virtual pivot axis 15Y and the pivot axis 40Y are maintained to coincide with each other (see FIGS. 6 and 7). When, for example, the user opens the thighs toward the right and left sides so as to stand firm for lifting up a heavy thing, there occurs at least one of pivoting of the actuator units 4R, 4L (see FIG. 1), including the thigh arm 51R and the left thigh arm, about the pivot axes 41RX, 41LX (see FIG. 1) and pivoting of the thigh arms to open toward the right and left sides by the connecting portion 56R and a left connecting portion. In this way, the actuator units 4R, 4L are opened toward the right and left sides (i.e. in the right-left direction) following the thighs opened to the right and left sides (i.e. in the right-left direction). Accordingly, even in the state where the user opens the thighs toward the right and left sides, it is possible to appropriately transmit the assist torques to the thighs.

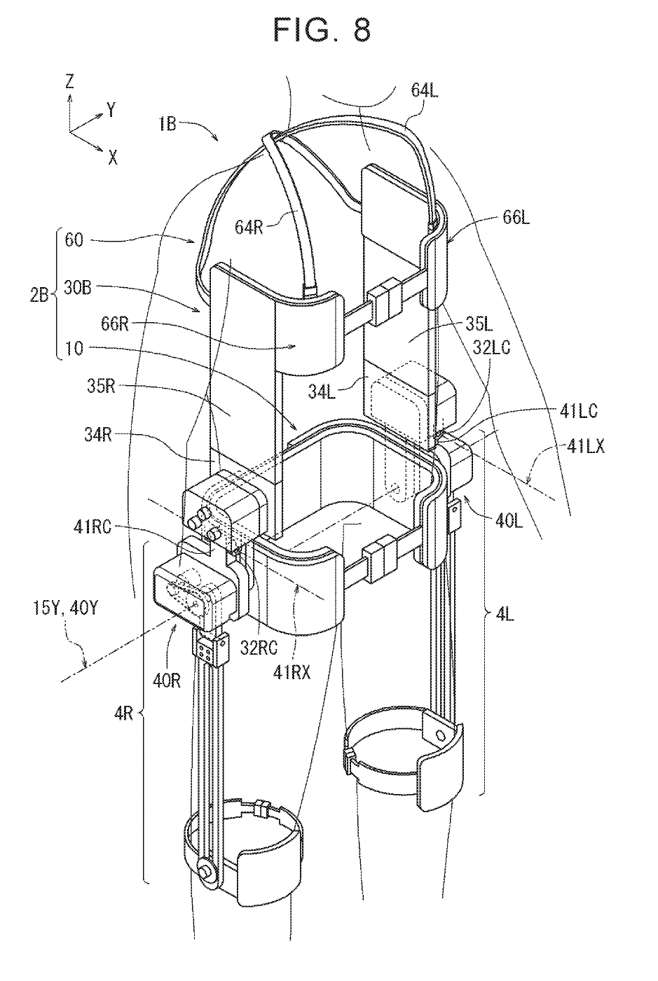

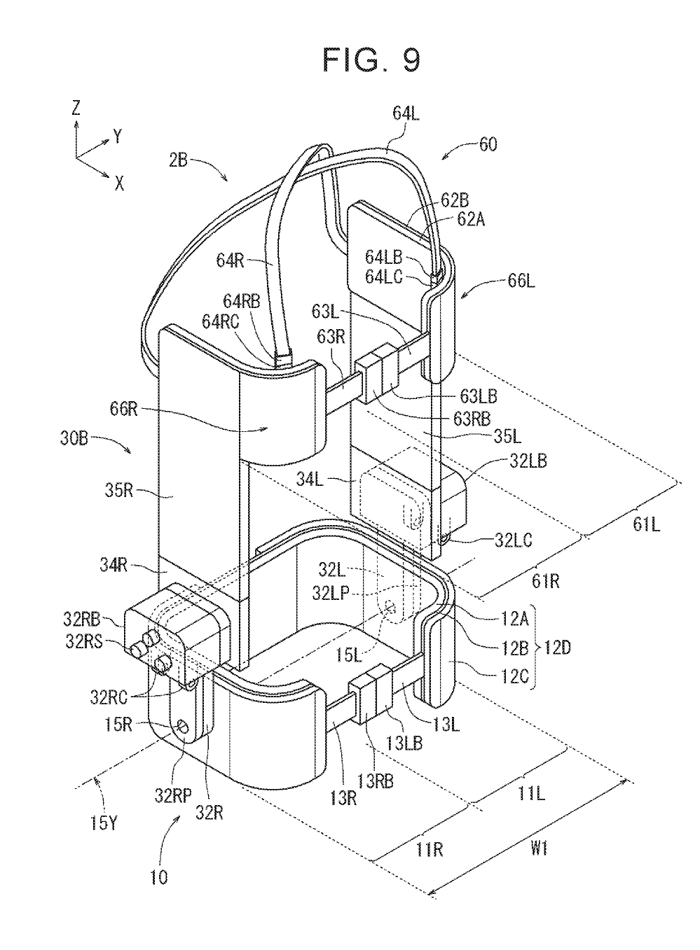

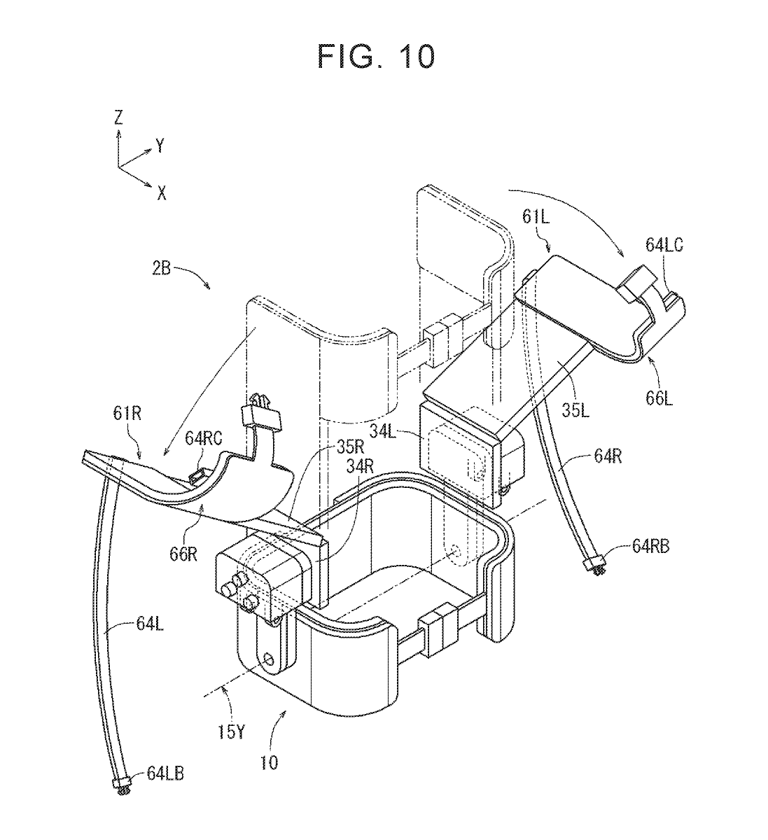

Referring to FIGS. 8 to 14, an assist device 1B of a second embodiment will be described. FIG. 8 shows the overall configuration of the assist device 1B of the second embodiment. The assist device 1B includes a body wearing unit 2B (see FIGS. 9 and 10), an actuator unit 4R (see FIG. 3), and an actuator unit 4L. While the assist device 1B (see FIG. 8) of the second embodiment differs from the assist device 1 (see FIG. 1) of the first embodiment in that the body wearing unit 2 (see FIG. 1) is changed to the body wearing unit 2B (see FIG. 8), the actuator units 4R, 4L are the same as those of the first embodiment. Hereinbelow, different points will be mainly described.

Referring to FIGS. 9 and 10, the overall configuration of the body wearing unit 2B will be described. As shown in FIGS. 9 and 10, the body wearing unit 2B includes a waist wearing portion 10 to be worn around the waist of a user, an upper half body wearing portion 60 to be worn at any position (an arbitrary position) in the upper half of the body of the user, and a frame portion 30B connecting the waist wearing portion 10 and the upper half body wearing portion 60 to each other. Since the waist wearing portion 10 is the same as the waist wearing portion 10 (see FIG. 2) of the first embodiment, a description thereof will be omitted. Accordingly, since the structure of a pivot mechanism and the structure of an opening angle imparting mechanism are also the same as those of the first embodiment, a description thereof will be omitted. In the waist wearing portion 10, a width W1 shown in FIG. 9 may be adjustable in accordance with a user. Hereinbelow, the upper half body wearing portion 60 and the frame portion 30B will be mainly described.

The upper half body wearing portion 60 includes a right upper half body wearing portion 61R to be worn at any position (an arbitrary position) in the right upper half of the body of the user and a left upper half body wearing portion 61L to be worn at any position (an arbitrary position) in the left upper half of the body of the user. The right upper half body wearing portion 61R includes a right chest wearing portion 66R, a belt 63R and a buckle 63RB, a right shoulder belt 64R and a buckle 64RB, and so on. Likewise, the left upper half body wearing portion 61L includes a left chest wearing portion 66L, a belt 63L and a buckle 63LB, a left shoulder belt 64L and a buckle 64LB, and so on. The right shoulder belt 64R, the left shoulder belt 64L, and the belts 63R, 63L are adjustable in length (using an adjuster, a buckle with an adjuster, or the like). The buckles 63RB, 63LB, 64RB, 64LB facilitate attachment and detachment of the upper half body wearing portion 60 to and from the user.

Each of the right chest wearing portion 66R and the left chest wearing portion 66L includes two layers, i.e. a pad portion 62A (e.g. an elastic member) with a predetermined thickness to be worn to cover the chest of the user and a cloth portion 62B disposed around the pad portion 62A. The buckle 63RB is connected to the front side of the right chest wearing portion 66R via the belt 63R. Likewise, the buckle 63LB is connected to the front side of the left chest wearing portion 66L via the belt 63L. In this way, a chest wearing portion (the right chest wearing portion 66R and the left chest wearing portion 66L) extending from the right armpit of the user to the left armpit of the user via the chest of the user is formed by the path including the right chest wearing portion 66R, the belt 63R (the buckle 63RB), the belt 63L (the buckle 63LB), and the left chest wearing portion 66L.

The front side of the right shoulder belt 64R is fitted via the buckle 64RB into a buckle 64RC provided at a front upper portion of the right chest wearing portion 66R. The rear side of the right shoulder belt 64R is connected to a rear upper portion of a left frame 35L (or the left chest wearing portion 66L). In this way, when the assist device 1B is worn by the user, the right shoulder belt 64R extends from the front side (front right side) of the upper half of the body of the user, then on the shoulder (right shoulder) of the user, to reach the left back side of the user (in other words, the right shoulder belt 64R extends from the front side (front right side) of the upper half of the body of the user, to reach the left back side of the user, through a position on the shoulder (right shoulder) of the user). Likewise, the front side of the left shoulder belt 64L is fitted via the buckle 64LB into a buckle 64LC provided at a front upper portion of the left chest wearing portion 66L. The rear side of the left shoulder belt 64L is connected to a rear upper portion of a right frame 35R (or the right chest wearing portion 66R). In this way, when the assist device 1B is worn by the user, the left shoulder belt 64L extends from the front side (front left side) of the upper half of the body of the user, then on the shoulder (left shoulder) of the user, to reach the right back side of the user (in other words, the left shoulder belt 64L extends from the front side (front left side) of the upper half of the body of the user, to reach the right back side of the user, through a position on the shoulder (left shoulder) of the user). Accordingly, when the assist device 1B is worn by the user, the right shoulder belt 64R and the left shoulder belt 64L cross each other on the back side of the user. Therefore, even when the user has a stooped posture, it is possible to correct the stooped posture so as to stretch the back muscles, and further, the right shoulder belt and the left shoulder belt (the upper half body wearing portion) can be firmly fixed around the shoulders of the user. The right shoulder belt 64R may be connected to the buckle 64LC of the left chest wearing portion 66L, while the left shoulder belt 64L may be connected to the buckle 64RC of the right chest wearing portion 66R. In this case, the right shoulder belt 64R and the left shoulder belt 64L do not cross each other on the back side of the user.

The frame portion 30B includes a right frame portion connecting a right waist wearing portion 11R and the right upper half body wearing portion 61R to each other, and a left frame portion connecting a left waist wearing portion 11L and the left upper half body wearing portion 61L to each other. The right frame portion includes the right frame 35R, a right frame 34R, a box 32RB, a pivotal portion 32R, a pad 32RP, and so on. The left frame portion includes the left frame 35L, a left frame 34L, a box 32LB, a pivotal portion 32L, a pad 32LP, and so on. Since the boxes 32RB, 32LB, the pivotal portions 32R, 32L, and the pads 32RP, 32LP are the same as those of the first embodiment, a description thereof will be omitted. Further, since a holding portion 32RC provided below the box 32RB and a holding portion 32LC provided below the box 32LB are also the same as those of the first embodiment, a description thereof will be omitted. In the second embodiment, a control device configured to control the actuator units 4R, 4L and a power supply are housed in the box 32RB, 32LB. The control device and the power supply may be disposed in a place other than the box 32RB, 32LB as long as each of the control device and the power supply does not interfere with the motion of the user or the operation of the assist device 1B.

As shown in FIGS. 9 and 10, the right frame 34R is fixed to the box 32RB. Likewise, the left frame 34L is fixed to the box 32LB. As shown in FIG. 10, the right frame 35R is configured to open in the rightward direction with respect to the user at a boundary portion with the right frame 34R. Likewise, the left frame 35L is configured to open in the leftward direction with respect to the user at a boundary portion with the left frame 34L. The right shoulder belt 64R can be detached from the right chest wearing portion 66R using the buckle 64RB, while the left shoulder belt 64L can be detached from the left chest wearing portion 66L using the buckle 64LB. As shown in FIG. 10, since the right frame 35R and the left frame 35L are configured to largely open toward the right and left sides, attachment of the assist device 1B to the user is facilitated. The right frame 35R and the left frame 35L are adjustable in vertical length.

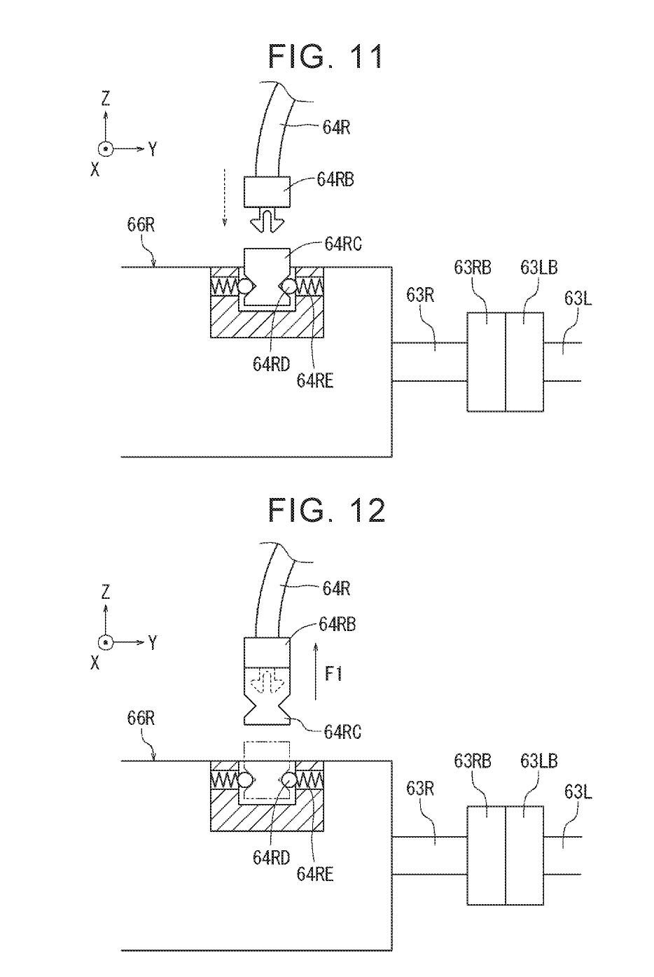

A release mechanism is provided for each of the right shoulder belt 64R and the left shoulder belt 64L. The release mechanism is configured to release the shoulder belt when a load greater than a preset release load is applied to the shoulder belt attached to the user. Hereinbelow, referring to FIGS. 11 and 12, the release mechanism will be described using the right shoulder belt 64R as an example. Since the release mechanism for the left shoulder belt 64L is the same as the release mechanism for the right shoulder belt 64R, a description thereof will be omitted. As shown in FIG. 11, the buckle 64RC is held by release load setting members 64RD, 64RE provided in the right chest wearing portion 66R. That is, the right shoulder belt 64R is connected to the release load setting members 64RD, 64RE via the buckle 64RC. FIGS. 11 and 12 show an example in which the release load setting members 64RD, 64RE are formed by spheres and elastic members. When the buckle 64RC is pulled upward by a force greater than the preset release load, the release load setting members 64RD, 64RE release the buckle 64RC. FIG. 12 shows an example of a state in which, by pulling the buckle 64RC upward by a force F1 greater than the preset release load, the buckle 64RC is released from the release load setting members 64RD, 64RE so as to be detached from the right chest wearing portion 66R.

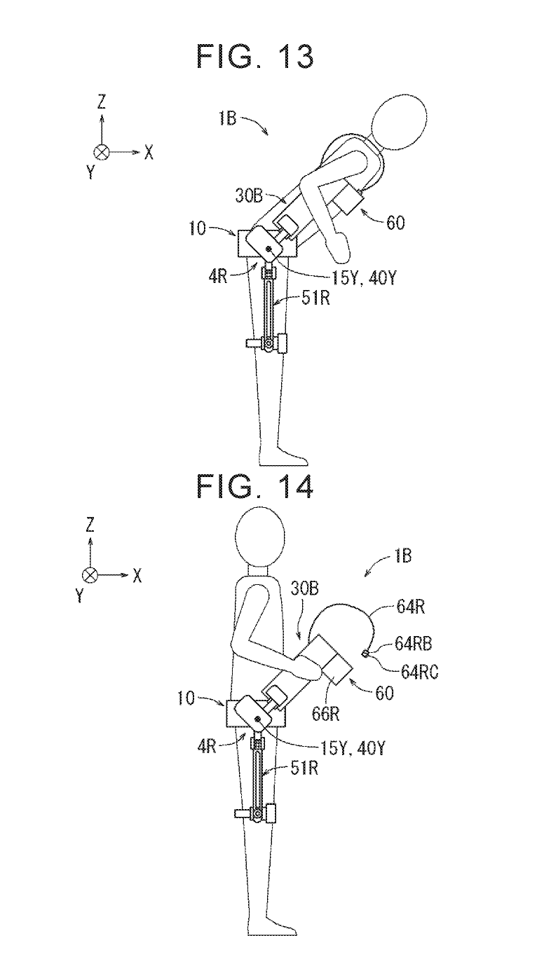

Consideration is given to a case where, for example, the actuator unit 4R becomes in a locked state (a thigh arm 51R is fixed so that the pivot angle does not change) in a state in which the user wearing the assist device takes a forward-bent posture as shown in FIG. 13. In the forward-bent posture shown in the example of FIG. 13, since the load is applied to the waist of the user, the user desires to take an easy posture by changing the posture from the forward-bent posture to an upright posture. However, it is not possible to change the posture to the upright posture in the state in which the actuator unit 4R is locked. With the above-described release mechanism, however, when the user applies a force by changing the posture from the forward-bent posture to the upright posture so that the force becomes greater than the preset release load, the right shoulder belt 64R and the left shoulder belt 64L (see FIG. 8) are released. Therefore, if the actuator unit becomes in a locked state, the user wearing the assist device can be safely released from the assist device. This release mechanism can be applied to the belts 13R, 13L and the belts 23R, 23L shown in FIG. 2, and when the release mechanism is applied, the user wearing the assist device shown in FIGS. 1 and 2 can be safely released from the assist device.

Effects of the disclosure will be described. In the assist devices 1 and 1B described in the first and second embodiments, the wearing position of the waist wearing portion with respect to the wearing position of the upper half body wearing portion is reliably positioned by the frame portion. Since the upper half body wearing portion is fixed to the user relatively firmly, even when reaction force to the assist torque generated by the actuator unit is received, displacement of the position of the waist wearing portion is suppressed. Further, since the pivot mechanism is provided, the frame portion is caused to pivot relative to the waist wearing portion about the virtual pivot axis, and therefore, even when the user makes a motion of bending the upper half of the body forward or backward, the frame portion is caused to pivot relative to the waist wearing portion so that displacement of the position of the waist wearing portion with respect to the user is suppressed. Therefore, the assist torque can be efficiently transmitted to the assist target body part of the user.

Since the assist devices 1 and 1B described in the first and second embodiments each have the opening angle imparting mechanisms, even when the user opens the thighs toward the right and left sides (opens the thighs in the right-left direction), it is possible to allow the thigh arms to follow the thighs opened toward the right and left sides, and thus, it is possible to appropriately transmit the assist torque. In a case where the opening angle (the above-described first opening angle) in the right-left direction is zero, no matter how the frame portion pivots relative to the waist wearing portion, the virtual pivot axis 15Y of the waist wearing portion and the pivot axis 40Y of the actuator unit coincide with each other as shown in FIGS. 7 and 13. Therefore, the assist torque can be appropriately transmitted to the assist target body part of the user.

In the assist device 1B described in the second embodiment, the right frame and the left frame are configured to open toward the right and left sides, and therefore, attachment and detachment of the assist device 1B to and from the user are facilitated. In the assist device 1B described in the second embodiment, the right shoulder belt 64R and the left shoulder belt 64L may or may not cross each other on the back side of the user. When the right shoulder belt 64R and the left shoulder belt 64L cross each other on the back side of the user, it is possible to correct a stooped posture of the user, and further, the upper half body wearing portion can be firmly fixed to the user. In the assist devices 1 and 1B of the first and second embodiments, by providing the above-described release mechanism, even if the actuator unit becomes in a locked state, it is possible to safely and easily release the user from the assist device.

Various modifications, additions, and deletions may be made to the structure, configuration, shape, external appearance, and so on of the assist device of the disclosure within the scope of the disclosure. For example, the structure of the actuator unit 4R is not limited to the structure shown in the example of FIG. 4. Further, while the example using the spiral spring 43R (see FIG. 4) has been described in the first and second embodiments, a torsion spring (a torsion bar or a torsion-bar spring) may be used instead of the spiral spring.

While the example in which the connection and release of the belts are performed using the buckles has been described for the assist devices 1 and 1B in first and second embodiments, the connection and release of the belts may be performed using members different from the buckles. Further, the upper half body wearing portion is not necessarily formed by both the shoulder belts and the chest wearing portions and may be formed by only one of them.

While the example in which the actuator units 4R, 4L are attached to the right and left sides of the body wearing unit has been described for the assist devices 1 and 1B in the first and second embodiments, the assist device may be configured such that only the actuator unit 4R is attached to the right side of the body wearing unit or only the actuator unit 4L is attached to the left side of the body wearing unit.

What is claimed is:

1. An assist device comprising:
a body wearing unit configured to be worn on a body of a user including a region around an assist target body part of the user; and
an actuator unit configured to be attached to the body wearing unit and to the assist target body part so as to assist a motion of the assist target body part,
wherein:
the body wearing unit includes a waist wearing portion configured to be worn around a waist of the user, an upper half body wearing portion configured to be worn at a position in an upper half of the body of the user, and a frame portion connecting the waist wearing portion and the upper half body wearing portion to each other;
a virtual pivot axis extending in a right-left direction of the user wearing the assist device is set at the waist wearing portion; and
the frame portion is connected to the waist wearing portion via a pivot mechanism configured to support the frame portion such that the frame portion is pivotable relative to the waist wearing portion about the virtual pivot axis.

2. The assist device according to claim 1, wherein:
a portion of the body wearing unit, to which the actuator unit is attached, is the frame portion;
the assist target body part to which the actuator unit is attached is a thigh; and
the actuator unit is attached to the frame portion via an opening angle imparting mechanism configured to cause the actuator unit to pivot in the right-left direction relative to the frame portion in accordance with an opening state of the thigh in the right-left direction, when the user wearing the assist device opens the thigh in the right-left direction.

3. The assist device according to claim 1, wherein:
the waist wearing portion includes a right waist wearing portion configured to be worn on a right half of the body of the user, and a left waist wearing portion configured to be worn on a left half of the body of the user;
the upper half body wearing portion includes a right upper half body wearing portion configured to be worn on a right half of the body of the user, and a left upper half body wearing portion configured to be worn on a left half of the body of the user; and
the frame portion includes a right frame portion connecting the right waist wearing portion and the right upper half body wearing portion to each other, and a left frame portion connecting the left waist wearing portion and the left upper half body wearing portion to each other.

4. The assist device according to claim 1, wherein:
the waist wearing portion includes a right waist wearing portion configured to be worn on a right half of the body of the user, and a left waist wearing portion configured to be worn on a left half of the body of the user; and
the frame portion includes a right-left link frame portion and a rear frame portion, the right-left link frame portion linking the pivot mechanism in the right waist wearing portion and the pivot mechanism in the left waist wearing portion, the rear frame portion connecting the right-left link frame portion and the upper half body wearing portion to each other, and the rear frame portion being disposed on a back side of the user.

5. The assist device according to claim 1, wherein the upper half body wearing portion includes a shoulder belt extending from a front side of the upper half of the body of the user wearing the assist device to reach a back side of the user, through a position on a shoulder of the user.

6. The assist device according to claim 5, wherein
the shoulder belt includes:
a right shoulder belt extending from a right side in the front side of the upper half of the body of the user wearing the assist device to reach a left side in the back side of the user, through a position on a right shoulder of the user; and
a left shoulder belt extending from a left side in the front side of the upper half of the body of the user wearing the assist device to reach a right side in the back side of the user, through a position on a left shoulder of the user.

7. The assist device according to claim 5, wherein a release mechanism is provided for the shoulder belt, the release mechanism being configured to release the shoulder belt when a load greater than a preset release load is applied to the shoulder belt attached to the user.

8. The assist device according to claim 7, wherein:
the release mechanism includes a release load setting member provided at the upper half body wearing portion, and a buckle held by the release load setting member;
the shoulder belt is connected to the release load setting member via the buckle; and
the release load setting member is configured to release the buckle when the load greater than the preset release load is applied to the shoulder belt.

9. The assist device according to claim 1, wherein the upper half body wearing portion includes a chest wearing portion extending from a right armpit of the user wearing the assist device to a left armpit of the user via a chest of the user.
